(19) United States
(12) Patent Application Publication
(10) Pub. No.: US 2005/0077729 A1
(43) Pub. Date: Apr. 14, 2005

(54) Combination of hose and hose connector

(76) Inventor: Huong Huong Fu, Chang-Hua Hsiang (TW)

Correspondence Address: Charles E. Baxley, Esquire, Third Floor, 90 John Street, New York, NY, 10038, US

(21) Appl. No.: 10/675,964

(22) Filed: Sep. 30, 2003

(51) Int. Cl. F16L 21/00

(52) U.S. Cl. 285/399

(57) ABSTRACT

A hose combination includes a flat hose having a first passage and each of two opposite insides of the first passage and two opposite outsides of the hose have a flange extending longitudinally therefrom. A connector includes a first part having a second passage defined therethrough and the hose is inserted in a first end of the first part. Two first grooves are defined in an inside of the second passage so as to receive the first flanges on the outside of the hose. A second part has a tubular portion which is inserted in the first passage and has second grooves defined in an outside thereof so as to receive the flanges on the two opposite insides of the first passage. A threaded neck extends from a second end of the first part and is connected to a third part to which a sprinkler is connected.

### FIELD OF THE INVENTION

The present invention relates to a flat hose with passages defined therethrough and flanges extending from an outside and inside of the passages, and a hose connector which is securely connected to the hose.

### BACKGROUND OF THE INVENTION

A conventional hose generally has a circular cross section and a passage is defined through the hose so that water flows in the passage. Nevertheless, it is experienced that the circular hose tends to be twisted or bent so that the area that allows the water to flow is reduced and this results high pressure at the faucet end and leakage is found at that end. Furthermore, when retrieving the hose, the section that is close to the faucet is bent at the same spot where the plastic hosing of the hose tends to be broken. The circular hose occupies larger space and is not convenient for those who have limited space for storing the hose. A hose connector is fixedly connected to an end of the hose so that a sprinkler and/or faucet can be connected to the connector by threads. The user has to rotate the sprinkler to be connected to the connector and this is not convenient for the user.

The present invention intends to provide a combination of a hose and a hose connector wherein the hose is a flat hose which occupies less space and the connector is securely connected to the flat hose without worry of leakage.

### SUMMARY OF THE INVENTION

In accordance with one aspect of the present invention, there is provided a hose combination which comprises a flat hose having a first passage and each of two opposite insides of the first passage and two opposite outsides of the hose have a flange extending longitudinally therefrom. A connector is composed of a first part, a second part and a third part. The first part has a second passage and the hose is inserted in a first end of the first part. Two first grooves are defined in an inside of the second passage so as to receive the first flanges on the outside of the hose. A second part has a tubular portion which is inserted in the first passage and has second grooves defined in an outside thereof so as to receive the flanges on the two opposite insides of the first passage. A threaded neck extends from a second end of the first part and is connected to a third part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hose and the connector of the present invention;

FIG. 2 is an exploded view to show the connector of the present invention;

FIG. 3 is a cross sectional view to show the first embodiment of the connector connected to the hose;

FIG. 4 is a cross sectional view to show the second embodiment of the connector connected to the hose, and

FIG. 5 is an end cross sectional view to show the combination of the hose and the connector.

### DETAILED DESCRIPTION OF THE PREFERRED EMBODIMENT

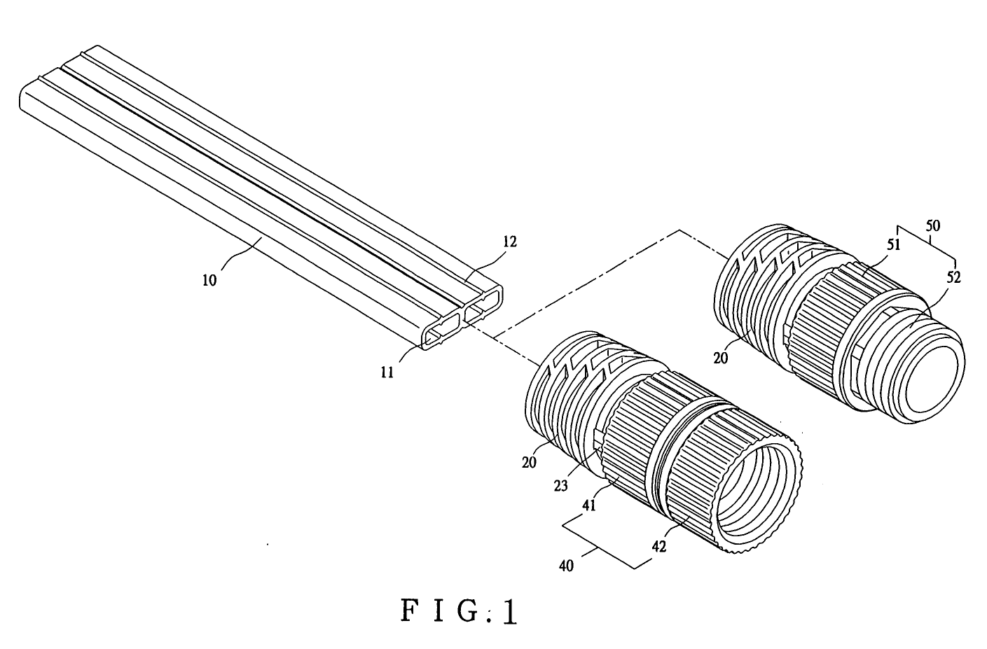

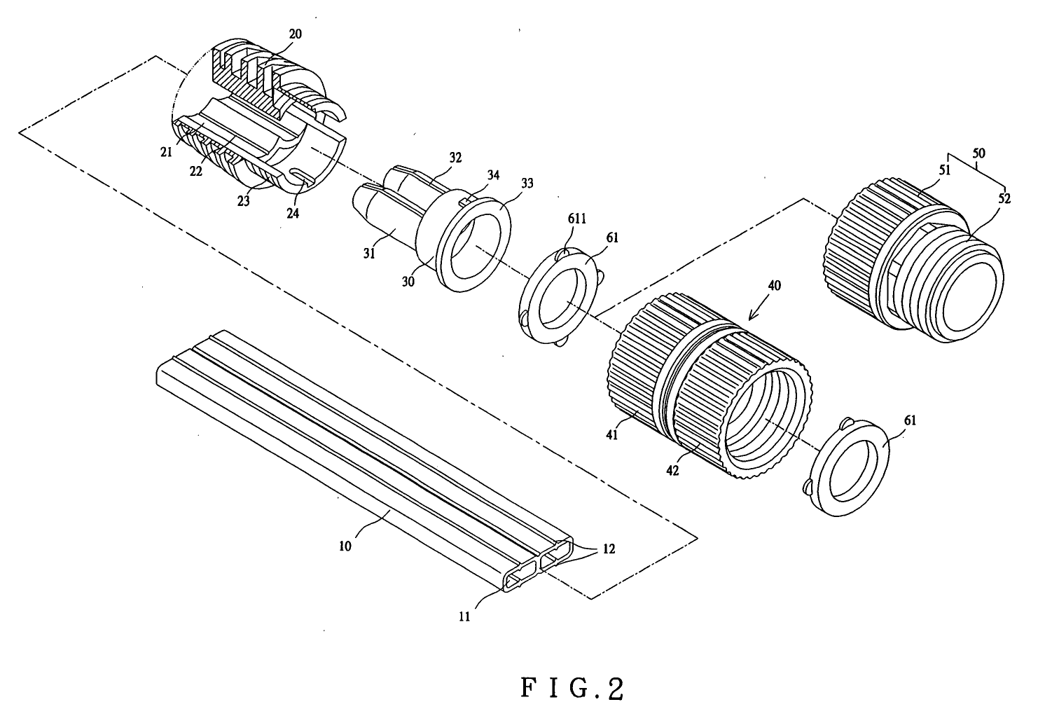

Referring to FIGS. 1 and 2, the hose combination of the present invention comprises a flat hose 10 having two first passages 11 defined therethrough. Each of two opposite insides of the first passages 11 and two opposite outsides of the hose 10 have a flange 12 extending longitudinally therefrom.

A connector is composed of a first part 20, a second part 30 and a third part 40 which is used to connect a sprinkler or a faucet. The first part 20 has a second passage 21 defined therethrough and the hose 10 inserted in a first end of the first part 20. The second passage 21 is formed into two parallel portions so as to correspond the two first passages 11. Two first grooves 22 defined in an inside of each portion of the second passage 21 so as to receive the first flanges 12 on the outside of the hose 10. A threaded neck 23 extends from a second end of the first part 20 and has a notch 24 defined in an inside thereof.

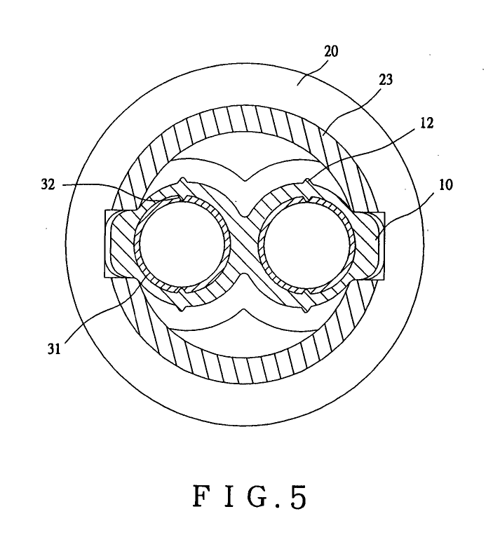

Further referring to FIG. 5, the second part 30 has two tubular portions 31 on one end thereof and each tubular portion 31 has a circular cross section. The two tubular portions 31 are inserted in the two first passages 11. Each tubular portion 31 has second grooves 32 defined in an outside thereof so as to receive the flanges 12 on the two opposite insides of the first passage 11 corresponding to the tubular portion 31. An end flange 33 is located at the other end of the second part 30 and has a tongue 34 which is engaged with the notch 24.

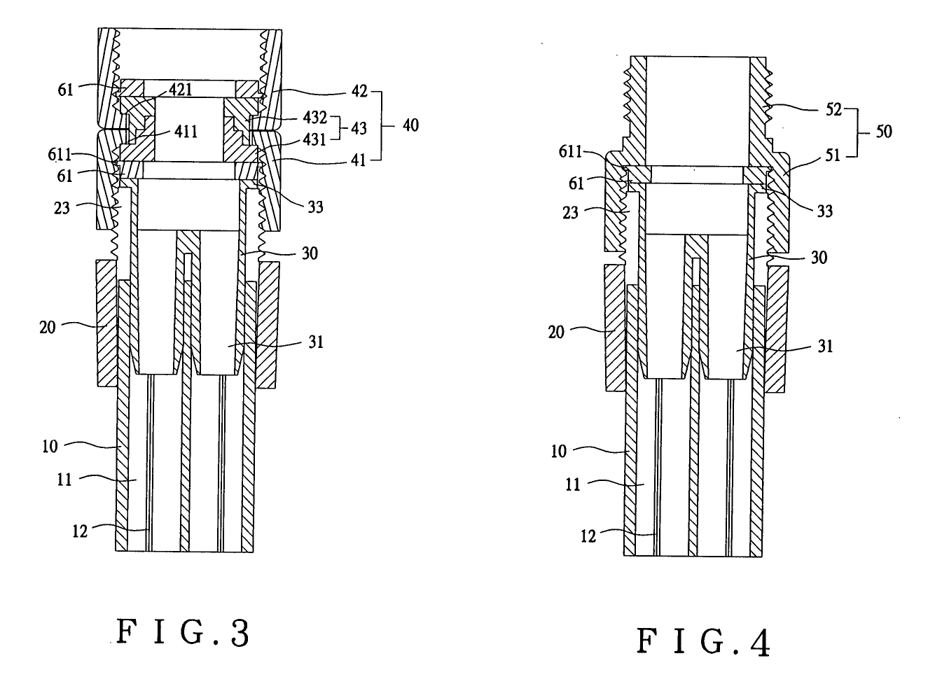

The third part 40 may have two embodiments wherein as shown in FIG. 3, the third part has a first portion 41 and a second portion 42. Each of the first portion 41 and the second portion 42 has an open end which includes a threaded inner periphery. The threaded inner periphery of the first portion 41 is connected to the threaded neck 23. Each of the first portion 41 and the second portion 42 has a connection piece 431/432 which is positioned by the end flange 411/421 of the first portion 41/second portion 42. Both of the connection pieces 431, 432 have stepped structure which is engaged with each other such that the first portion 41 and the second portion 42 are rotatable relative to the two respective connection pieces 431, 432, and the first portion 41 and the second portion 42 are independently rotatable from each other. Seals 61 are installed in the first portion 41 and the second portion 42 so as to prevent from leakage. Each seal 61 includes a protrusion 611 which is engaged with the threads of the threaded inner periphery of the open end of each of the first portion 41 and the second portion 42. The second portion 42 is able to connect a faucet or sprinkler.

Referring to FIG. 4, the other embodiment of the third part 40 includes a first portion 51 and a second portion 52 which is integrally formed with the first portion 51. The first portion 51 has an open end which has a threaded inner periphery so as to be connected to the threaded neck 235. The second portion 52 has a threaded outer periphery so as to be connected to a faucet or sprinkler.

While we have shown and described the embodiment in accordance with the present invention, it should be clear to those skilled in the art that further embodiments may be made without departing from the scope of the present invention.

1. A hose combination comprising:
a flat hose having a first passage defined therethrough, each of two opposite insides of the first passage and two opposite outsides of the hose having a flange extending longitudinally therefrom, and
a connector comprising a first part having a second passage defined therethrough and the hose inserted in a first end of the first part, two first grooves defined in an inside of the second passage so as to receive the first flanges on the outside of the hose, a second part having a tubular portion which is inserted in the first passage and has second grooves defined in an outside thereof so as to receive the flanges on the two opposite insides of the first passage, a threaded neck extending from a second end of the first part and being connected to a third part.

2. The combination as claimed in claim 1, wherein the threaded neck of the first part has a notch defined in an inside thereof and the second part has an end flange having a tongue which is engaged with the notch.

3. The combination as claimed in claim 1, wherein the third part has a first portion and a second portion, each of the first portion and the second portion having an open end which includes a threaded inner periphery, the threaded inner periphery of the first portion being connected to the threaded neck, the first portion and the second portion being independently rotatable from each other.

4. The combination as claimed in claim 3, wherein each of the first portion and the second portion has a connection piece connected thereto and the first portion and the second portion are rotatable relative to the two respective connection pieces, the two connection pieces being engaged with each other.

5. The combination as claimed in claim 1, wherein the third part includes a first portion and a second portion, the first portion having an open end which has a threaded inner periphery connected to the threaded neck, the second portion has a threaded outer periphery.

6. The combination as claimed in claim 1, wherein the tubular portion has a circular cross section.

7. The combination as claimed in claim 4, wherein two seals are installed in the first portion and the second portion of the third part respectively, each seal including a protrusion which is engaged with threads of the threaded inner periphery of the open end of each of the first portion and the second portion.
